(19) United States
(12) Patent Application Publication
(10) Pub. No.: US 2007/0086700 A1
(43) Pub. Date: Apr. 19, 2007

(54) Optical fiber array

(76) Inventor: Allen Weng, Lujhu Township (TW)

Correspondence Address: HDSL, 4331 STEVENS BATTLE LANE, FAIRFAX, VA, 22033, US

(21) Appl. No.: 11/249,522

(22) Filed: Oct. 14, 2005

(51) Int. Cl. G02B 6/32

(52) U.S. Cl. 385/33; 385/34; 385/74

(57) ABSTRACT

An optical fiber array includes two more glass containers each with a cylindrical shape. Each container contains an optical fiber, including a convex face on outer side thereof to provide light focusing effect. Four straight bridging sections are extended symmetrically from the container and one bridging section is connected to another container to form an array-type base. Moreover, the bridging section can be an assembling and locking structure to form base with flexible shape.

### BACKGROUND OF THE INVENTION

1. Field of the Invention

The present invention relates to an optical fiber array, especially to an optical fiber array with optical effect and flexible in shape thereof.

2. Description of Prior Art

As rapid progress of communication technology, the communication speed and bandwidth are more and more demanding for electronic devices. Therefore the conventional network for data transmission such as cables are gradually replaced by medium supporting optical transmission. More particularly, parallel fiber arrays can be used for facilitating assembling of optical network.

The light beam will have refraction and diffraction when the light beam leaves from the optical fiber and propagates to other medium such as air or liquid. The attenuation caused by the refraction and diffraction of the light beam is proportional to the propagation distance of the light beam. Therefore, the light will be attenuated when the light beams propagates from one medium to another medium such as another optical fiber. Therefore, alignment lens is generally used to mount at end of optical fiber to prevent diffraction of the light beam.

FIG. 1 shows a prior art optical fiber array and the alignment lens thereof. The alignment lens 40 is arranged on a lens base 41. A parallel fiber array 20 is fixed to the fiber base 10. The position of the alignment lens 40 should be aligned with exit end of the fiber array 20. However, the lens base 41 is generally made of material with different thermal expansion coefficient from that of the fiber base 10. The position of the alignment lens 40 will not be aligned with exit end of the fiber array 20 when temperature changes. This problem is more serious when the base has larger area.

### SUMMARY OF THE INVENTION

It is an object of the present invention to provide an optical fiber array having normal function in environment of varying temperature. The relative position between the fiber array and lens are fixed and not changed with temperature. The shape of the base for the present invention can be flexibly assembled. It is another object of the present invention to provide an optical fiber array with ease in cutting to change shape thereof.

Preferably, the present invention provides an optical fiber array, which includes at least one glass container with cylindrical shape and each container contains an optical fiber. Each of the containers includes a convex face on outer side thereof to provide light focusing effect. Four straight bridging sections are extended symmetrically from the container and one bridging section is connected to another container to form an array-type base. Moreover, the bridging section can be assembling and locking structure to form base with flexible shape.

Moreover, lens is directly formed on bottom side of fiber base and the fiber is embedded into container formed in front of the lens. The relative position between the fiber array and lens are fixed and not changed with temperature. The base is formed by at least one container connected with straight-shaped bridging section and placed in coplanar fashion. Therefore, the base can be easily cut in desired shape. The bridging section has lockable shape to assemble base with desirable shape.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a sectional view of a prior art optical fiber array.

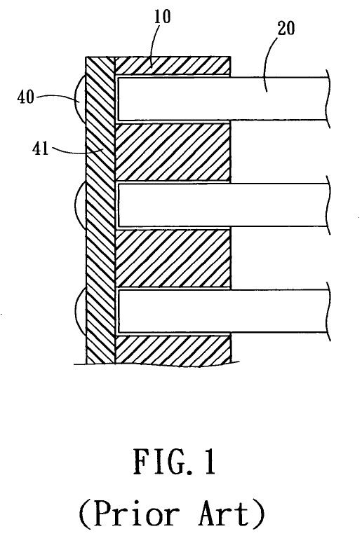

FIG. 2 shows a perspective view of the first preferred embodiment of the present invention.

FIG. 3 shows a perspective view of the second preferred embodiment of the present invention.

FIG. 4 shows a perspective view of the present invention.

FIG. 5 shows a perspective view of the third preferred embodiment of the present invention.

FIG. 6 shows a partially enlarged view of the third preferred embodiment of the present invention.

FIG. 7 shows a perspective view of the fourth preferred embodiment of the present invention.

### DETAILED DESCRIPTION OF THE INVENTION

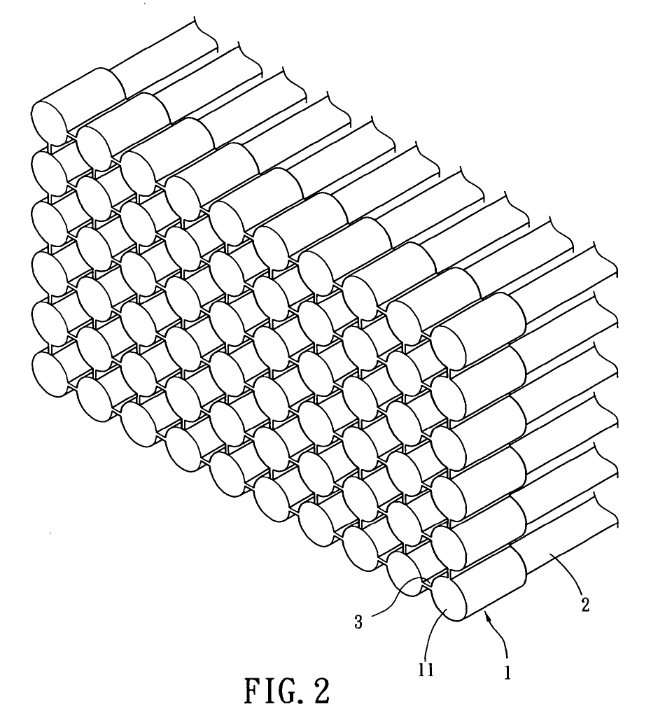

FIG. 2 shows a perspective view of the present invention. The fiber array device comprises a base 1 and a parallel optical array 2 therein. The base 1 comprises a plurality of straight bridging sections 3 to connect a plurality cylindrical containers 11 into 6×10 array arrangement. The base 1 is preferably made of material with high refractive index and light transparency such as glass. More than one cylindrical container 11 is arranged in coplanar manner. It is known to the skill in the art that the container 11 can be other shape than cylindrical shape as long as the inner diameter of the container 11 can accommodate the outer diameter of the fiber. Therefore, the fibers can be retained on the base to form 6×10 array arrangement.

As also shown in FIG. 2, the bridging sections 3 are extended symmetrically from the container 11. Therefore, the cylindrical containers 11 are connected through the rectangular bridging sections 3 therebetween. Moreover, the rectangular bridging sections 3 have smaller width than the cylindrical containers 11. Array with different numbers of the cylindrical containers 11 can be defined by cutting the bridging sections 3. Therefore, fiber array of different sizes can be easily achieved.

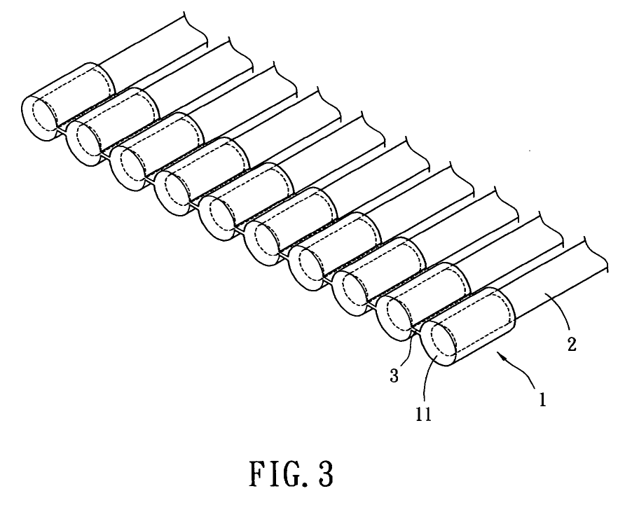

FIG. 3 shows a base 1 for 1×10 optical fiber array. It should be noted that the parallel fiber arrays on the base 1 can be other number than 1×10 or 6×10.

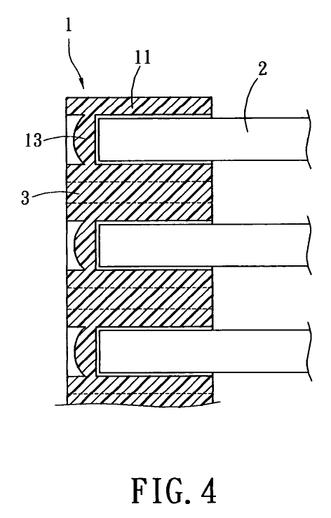

To maintain normal operation of the fiber and the alignment lens under different temperatures, as shown in FIGS. 3 and 4, the container 11 has a convex face on outer face thereof, such as a spherical face or a parabola face. The convex face provides a lens 13 placed in front of the fiber and provides a focusing effect similar to the plano convex lens. The lens 13 provided by the convex face is integrally with the container 11 such that the fiber 2 will be not shifted due to temperature variation, and the fiber end can still be aligned with lens.

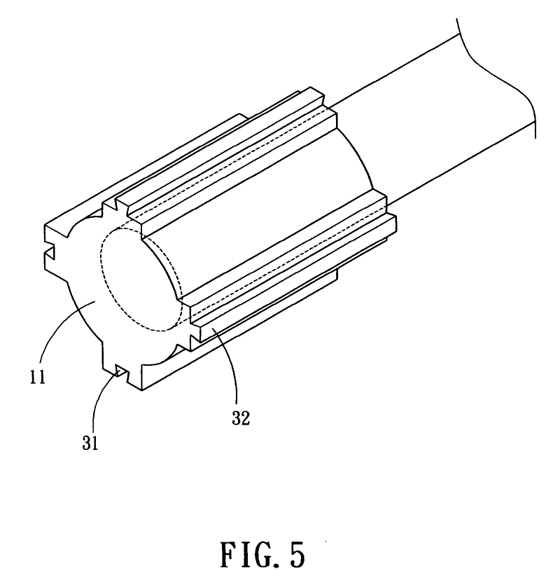

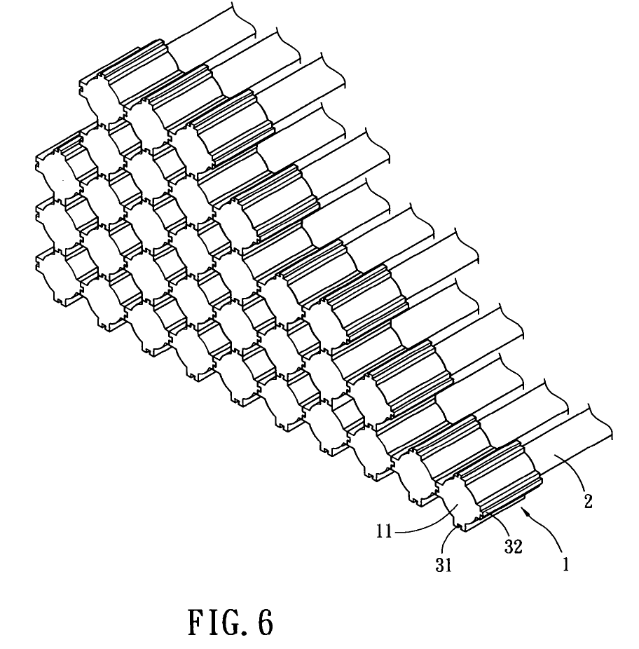

FIG. 5 shows the third preferred embodiment of the present invention, wherein the base 1 is a detachable structure. The container 11 comprises four bridging sections 3 of symmetrical rectangular shape. More particularly, two bridging section 3 alone the same line are formed into flanges 32 and two bridging section 3 alone the same line are formed into dents 31. The flange 32 and the dent 31 are such designed that they can be engaged with each other as shown in FIG. 6.

With reference to FIG. 6, a plurality of containers 11 is assembled into base 1 by the engagement of the second bridging section 32 and the fourth bridging section 31. The bridging section can be assembled with other container 11 to form fiber array with more flexibility.

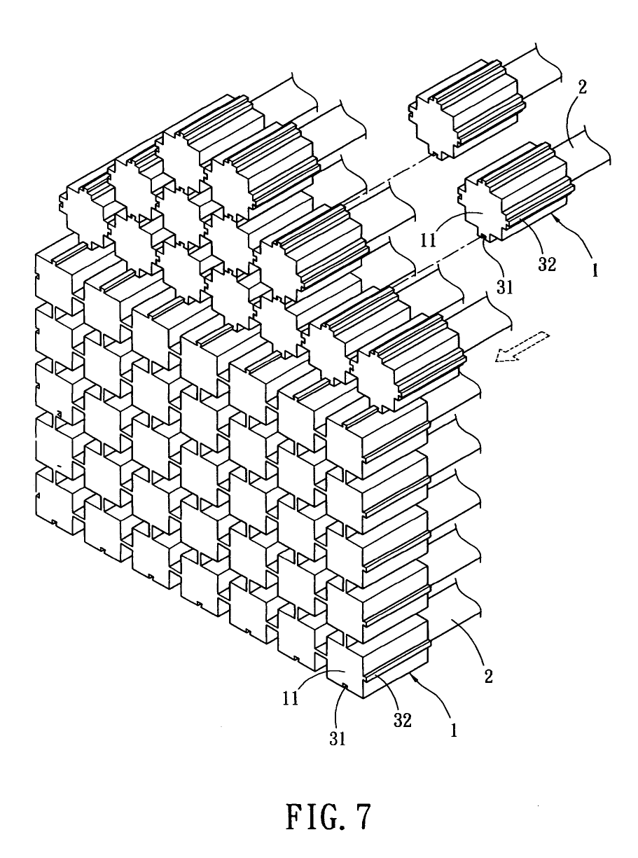

As shown in FIG. 7, the container 11 is rectangular body with opening on topside thereof and is connected to other container 11 with bridging section such that a 7×5 base 1 is formed. Moreover, the 7×5 base 1 can be assembled with other assembly-type container 11.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An optical fiber array, comprising:
two more containers each being a hollowed cylinder with an opening on one side thereof;
at least one bridging section being a rectangular body extended outward from each container, one end of the bridging section being connected to a bridging section of another container;
wherein the containers connected on two ends of the bridging section are coplanar.

2. The optical fiber array as in claim 1, wherein the container is made of material with high transparency.

3. The optical fiber array as in claim 2, wherein the container is made of glass.

4. The optical fiber array as in claim 1, wherein the container is made of material with high refraction ratio.

5. The optical fiber array as in claim 4, wherein the container is made of glass.

6. The optical fiber array as in claim 1, wherein the container has a convex face with light focusing effect.

7. The optical fiber array as in claim 1, further comprising an optical fiber embedded into each container.

8. The optical fiber array as in claim 1, further comprising a plurality of bridging sections integrally assembled.

9. The optical fiber array as in claim 8, wherein the bridging sections are connected by locking.

10. The optical fiber array as in claim 8, wherein one bridging section has a dent and another bridging section has a flange for each container so that two containers can be engaged with each other by the dent and the flange.
